(19) United States
(12) Patent Application Publication
(10) Pub. No.: US 2008/0130045 A1
(43) Pub. Date: Jun. 5, 2008

(54) MULTI-FUNCTION APPARATUS

(75) Inventors: Hirofumi Oguri, Nagoya-shi (JP); Tetsuya Kato, Chiryu-shi (JP); Tatsuya Sato, Ichinomiya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 11/949,702

(22) Filed: Dec. 3, 2007

(30) Foreign Application Priority Data
Dec. 4, 2006 (JP) 2006326689

(51) Int. Cl. G06F 3/12

(52) U.S. Cl. 358/1.15

(57) ABSTRACT

A multi-function apparatus, including: a plurality of processing and outputting sections which have respective functions and each of which sequentially conducts a plurality of jobs in each of which a processing related to image data provides an output, according to a corresponding one of the functions, wherein the plurality of processing and outputting sections comprise, as at least a portion thereof, a plurality of specific processing and outputting sections; and a job-displaying section configured to display a plurality of to-be-conducted jobs each of which is to be conducted by any of the specific processing and outputting sections, such that the to-be-conducted jobs are separated into a plurality of groups corresponding to the specific processing and outputting sections, respectively.

### CROSS REFERENCE TO RELATED APPLICATION

The present application claims priority from Japanese Patent Application No. 2006-326689, which was filed on Dec. 4, 2006, the disclosure of which is herein incorporated by reference in its entirety.

### BACKGROUND OF THE INVENTION

1. Field of the Invention

The present invention relates to a multi-function apparatus which has a plurality of functions related to an image processing.

2. Description of the Related Art

There is conventionally known an image processing apparatus such as a recording apparatus configured to provide a recording output in which an image is recorded on a recording sheet on the basis of inputted data, and a facsimile apparatus configured to send data which is read by a scanner. The image processing apparatus generally divides inputted data into controllable units each of which is set as a “job”, and controls a processing order, permission and inhibition of conduction of each job, and the like. The image processing apparatus is also configured to change the processing order and to cancel or pause the output.

Japanese Patent Application Publication No. 10-333848 discloses one example of such an image processing apparatus which detects a job waiting for being conducted and which updates and displays a processing order periodically at predetermined time intervals. This configuration permits a user to recognize the processing order of the jobs waiting for being conducted, whereby the user can change the processing order of the jobs.

### SUMMARY OF THE INVENTION

However, for example, a multi-function apparatus integrally including a plurality of outputting device such as a recording device and a facsimile device suffers from a problem that it is difficult to accurately recognize an actual timing of conducting each job on the basis of a display or view in which the jobs waiting for being conducted are merely arranged in order because the outputting device are independently operated.

Further, when the user cannot accurately recognize the actual timing of conducting each job, the multi-function apparatus may cause the user to perform useless operations.

For example, in the case where a job 1 is waiting for a recording processing, and a job 2 which is set after setting of the job 1 is waiting for a sending processing in a facsimile communication, when the facsimile sending processing precedes the recording processing, the job 2 may be conducted earlier than the job 1. That is, an order in which the jobs are conducted in the multi-function apparatus may differ from an order in which the jobs have been actually conducted. In this case, if the user performs a changing operation of the processing order in which the processing order is changed such that the job 1 is to be conducted earlier than the job 2, the changing operation has no use.

This invention has been developed to solve the above-described problem, and it is an object of the present invention to provide a multi-function apparatus that permits a user to easily and intuitively recognize a state in which each job is actually conducted, and that provides high usability.

The object indicated above may be achieved according to the present invention which provides a multi-function apparatus including: a plurality of processing and outputting sections which have respective functions and each of which sequentially conducts a plurality of jobs in each of which a processing related to image data provides an output, according to a corresponding one of the functions, wherein the plurality of processing and outputting sections comprise, as at least a portion thereof, a plurality of specific processing and outputting sections; and a job-displaying section configured to display a plurality of to-be-conducted jobs each of which is to be conducted by any of the specific processing and outputting sections, such that the to-be-conducted jobs are separated into a plurality of groups corresponding to the specific processing and outputting sections, respectively.

In the thus constructed multi-function apparatus, it is easy for a user to intuitively recognize the state in which each job is actually conducted. Thus, a high usability is provided.

### BRIEF DESCRIPTION OF THE DRAWINGS

The above and other objects, features, advantages, and technical and industrial significance of the present invention will be better understood by reading the following detailed description of preferred embodiments of the invention, when considered in connection with the accompanying drawings, in which:

FIG. 1 is a perspective illustration showing an external construction of a multi-function apparatus as an embodiment of the present invention;

FIG. 2 is a perspective illustration showing the external construction of the multi-function apparatus with a document cover thereof opened;

FIG. 3 is a block diagram showing a schematic construction of a control section of the multi-function apparatus;

FIG. 4 is a block diagram schematically showing a relationship between main sections and functions of the multi-function apparatus;

FIG. 5 is an illustration showing an example of a normal view which represents processing orders of jobs;

FIG. 6A is an illustration showing an example of a change-start view;

FIG. 6B is an illustration showing an example of a preview view;

FIG. 6C is an illustration showing an example of an insertion-position-determining view;

FIG. 7A is an illustration showing an example of a change-object-job-dealing view;

FIG. 7B is an illustration showing a normal view after a change of the processing order of the jobs;

FIG. 8 is a flow chart indicating a flow of a accepting processing of the jobs;

FIG. 9 is a flow chart indicating a flow of an output processing for the jobs; and

FIG. 10 is a flow chart indicating a flow of a changing transaction.

### DESCRIPTION OF THE PREFERRED EMBODIMENT

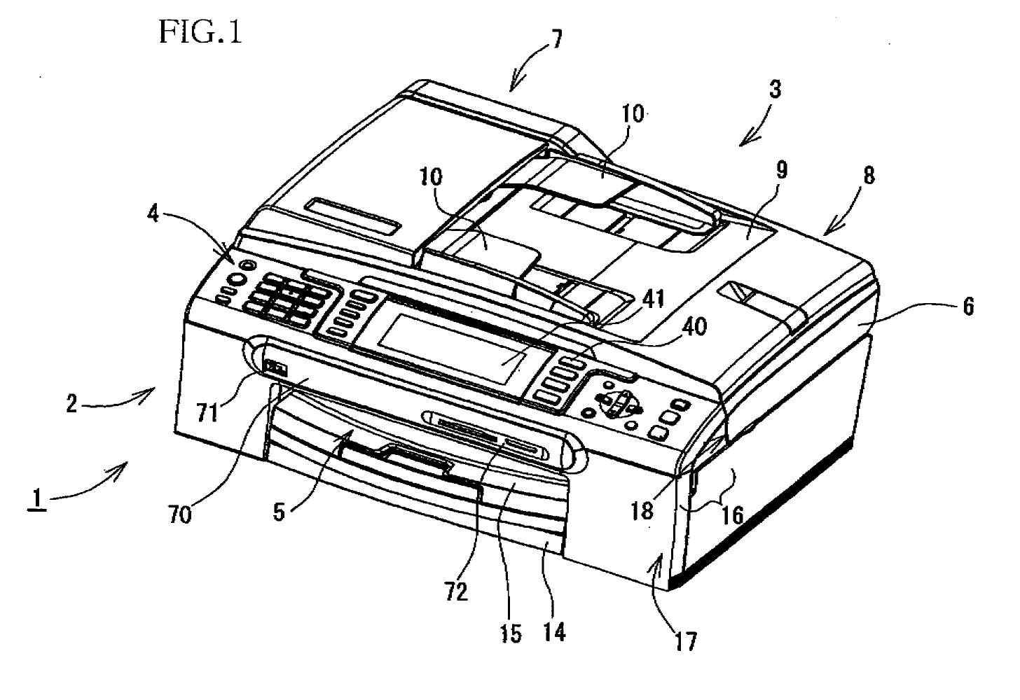

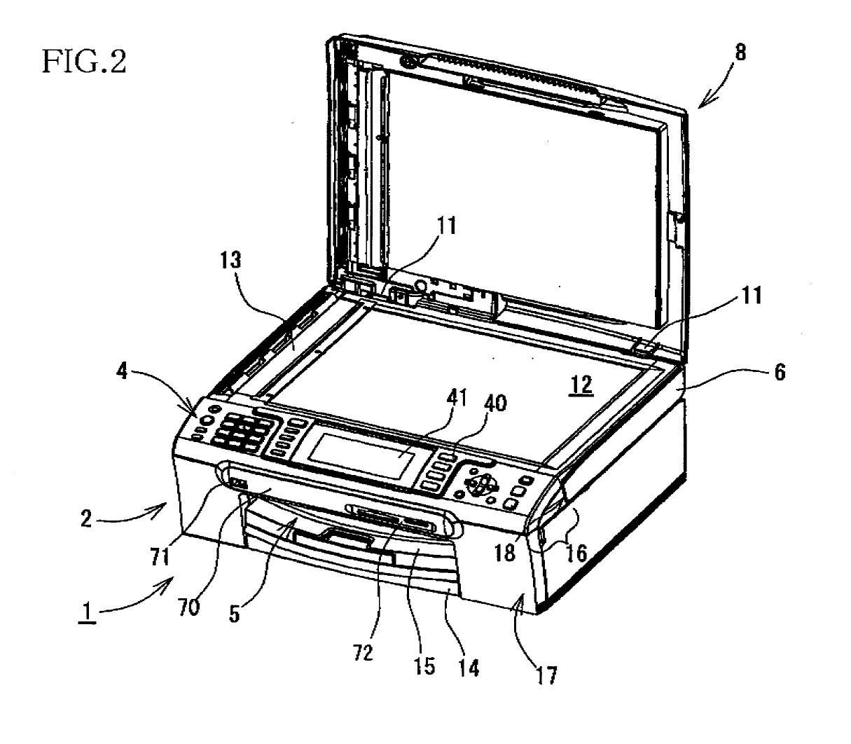

Hereinafter, there will be explained preferred embodiment of the present invention with reference to the accompanying drawings. FIG. 1 is a perspective illustration showing an external construction of a multi-function apparatus 1 as an embodiment of the present invention. It is noted that because the multi-function apparatus 1 is also called a multi-function device, hereinafter, the multi-function apparatus 1 will be referred to as a MFD 1. FIG. 2 is a perspective illustration showing the external construction of the MFD 1 with a document cover 8 thereof opened. It is to be understood that the following embodiment is described only by way of example, and the invention may be otherwise embodied with various modifications without departing from the scope and spirit of the invention.

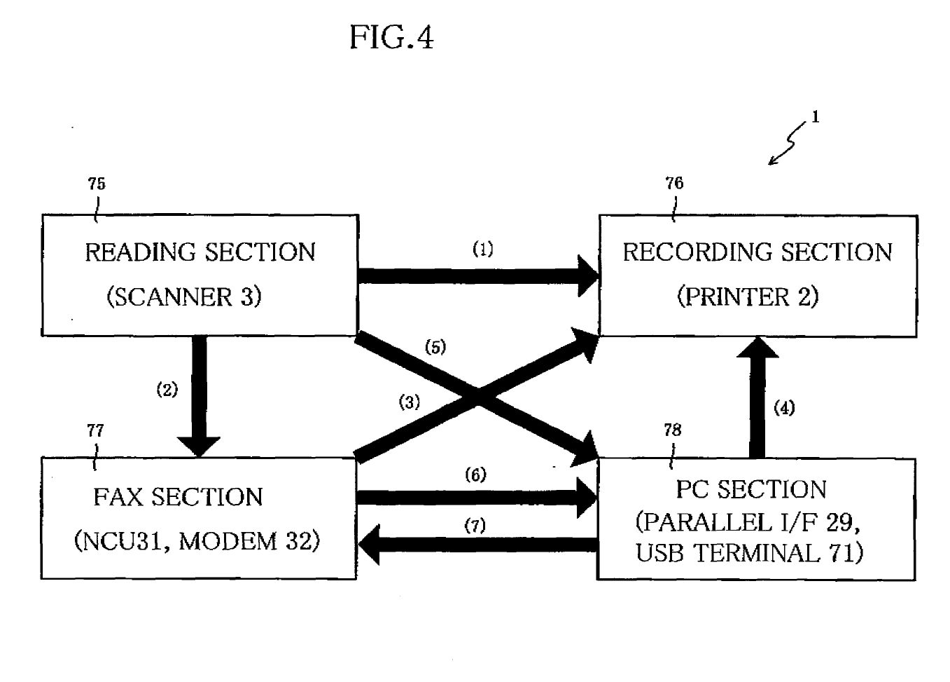

As shown in FIGS. 1 and 2, the MFD 1 includes a printer 2 at its lower portion, a scanner 3 at its upper portion, and an operation panel 4 in front of the scanner 3, integrally. It is noted that, in this embodiment, a side of the MFD 1 on which the operation panel 4 is located is referred to as a front side, and rear, right, and left sides are defined based on the front side in a state in which the MFD 1 is seen from the front side. The MFD 1 realizes several functions such as a copying function, a facsimile function, and a printing function in which images or characters are recorded or printed on a recording medium based on data received from an external computer (not shown) such as a personal computer (PC). These functions will be described in detail with reference to FIG. 4.

The scanner 3 includes: a document reading table 6 functioning as a flatbed scanner (FES); and a document cover 8 equipped with an auto document feeder 7 (hereinafter, referred to as ADF). The document cover 8 is attached to the document reading table 6 via hinges 11 (shown in FIG. 2) at a rear side of the MFD 1 so as to be opened and closed. As shown in FIG. 2, a platen glass 12 is provided on an upper surface of the document reading table 6. An image-reading unit (not shown) is incorporated in the document reading table 6.

The platen glass 12 has a rectangular shape, in its plan view, in which its widthwise dimension (as measured in a left-right direction of the MFD 1) is larger than its lengthwise dimension (as measured in a front-rear direction of the MFD 1). The platen glass 12 has a size in which a rectangular document can be placed thereon such that a longitudinal side of the rectangular document extends in the left-right direction of the MFD 1, in other words, in a widthwise direction of the MFD 1.

The document reading table 6 has, in an upper surface thereof, an relatively large opening into which the platen glass 12 is fitted. Within the document reading table 6, there are a space for a movement of the image-reading unit and a space for disposition of the image-reading unit, supporting members for supporting the image-reading unit, and drive mechanisms for driving the image-reading unit. Accordingly, the upper surface of the document reading table 6 is larger in size than the platen glass 12. The document reading table 6 has a shape, in its plan view, generally similar to that of the platen glass 12. That is, the document reading table 6 has a rectangular parallelepiped shape having a predetermined height and widthwise dimension which is larger than its lengthwise dimension in its plan view like the platen glass 12.

Where the thus constructed scanner 3 is used as the FBS, the document cover 8 is opened upward, and then a document is placed on the platen glass 12. Then, the document cover 8 is closed downward so as to fixedly position the document on the platen glass 12. Thereafter, upon inputting of a reading-start command, the image-reading unit is moved along a back surface (i.e., a lower surface) of the platen glass 12 so as to scan the document. Thus, an image-reading for the document is performed by the scanner 3 as the FBS.

The image-reading unit includes a line image sensor whose main scanning direction corresponds to a depth direction (i.e., the lengthwise direction) of the MFD 1. The image-reading unit reads an image in the following manner. The document is irradiated with a light generated by a light source, and a reflected light from the document is led to photoelectric converting elements by a lens. The photoelectric converting elements output electric signals in accordance with the intensity of the reflected light, whereby the image is read. As the line image sensor, there may be employed a Contact Image Sensor (CIS) of a close-contact type, a Charge Coupled Device (CCD) of a reduction optical type, a Complementary Metal-Oxide Semiconductor (CMOS), or the like. It is noted that internal structures of the image-reading unit and the scanner 3 are not directly relevant to the present invention, and thus a detailed explanation of the structures is dispensed with.

The ADF 7 feeds a document from a document-supply tray 9 to a document-discharge tray 10 through a document-feed path. During the feeding of the document by the ADF 7, when the document passes a reading place 13 located on the document reading table 6, an image of the document is read by the image-reading unit standing by below the reading place 13. The image-reading by using the ADF 7 is performed with the document cover 8 closed downward so as to cover the document reading table 6. In the present invention, the ADF 7 may have any suitable structure. Further, the scanner 3 may not include the ADF 7 and may perform the image-reading operation only as the FBS, and a detailed explanation of the ADF 7 is dispensed with.

The printer 2 is an image recording device configured to record an image on a recording sheet as a recording medium based on the image data read by the scanner 3 or inputted from an external device. As described above, the printer 2 is disposed below the scanner 3. Since the printer 2 and the scanner 3 are positioned to each other such that back surfaces of the printer 2 and the scanner 3 are flush with each other, the MFD 1 has a flat back surface with no unevenness Needless to say, various image recording methods such as an electrophotographic method and a thermal transfer method may be employed as an image recording method of this printer 2.

An opening 5 is formed in a front portion of the MFD 1, namely, in a front portion of the printer 2. In the opening 5, a sheet-supply tray 14 and a sheet-discharge tray 15 are provided so as to be accommodated completely in the MFD 1. The sheet-supply tray 14 and the sheet-discharge tray 15 are disposed so as to have a two-tier structure in a vertical direction in which the sheet-discharge tray 15 is located above the sheet-supply tray 14.

As described above, the document reading table 6 has the oblongly rectangular parallelpiped shape. Thus, a front end face 17 of the printer 2 projects from a front end face 18 of the scanner 3 by a predetermined distance. Hereinafter, an end portion on the front side of the printer 2 that projects forwardly from the end face 18 will be referred to as a projecting portion 16. It is noted that a widthwise dimension of the printer 2 corresponds to that of the scanner 3. Accordingly, the MFD 1 has a generally square shape in its plan view.

In the printer 2, there is formed a U-turned sheet-feed path which extends upward from a rear side of the sheet-supply tray 14 and is then curved frontward so as to be connected to the sheet-discharge tray 15. Each of recording sheets accommodated in the sheet-supply tray 14 is supplied to the sheet-feed path with its short side fed as a leading end. Then, each sheet is carried through the sheet-feed path in a U-turn manner, so as to be guided to a recording position provided in the sheet-feed path. At the recording position, an image is recorded on the recording sheet. The recording sheet on which the image has been recorded is discharged to the sheet-discharge tray 15.

A connecting panel 70 is provided above the opening 5 of the printer 2. In the connecting panel 70, a USB terminal 71 is provided at a left end portion thereof. The USB terminal 71 functions as a connector terminal which is connected to the external device via USB connection so as to permit the MFD 1 to communicate with the external device. In the connecting panel 70, a slot portion 72 is provided at a right end portion thereof. The slot portion 72 includes a plurality of card slots into each of which a memory card can be mounted. When the memory card is mounted into one of the card slots, image data is read out from the memory card by a control section 20 which will be described below.

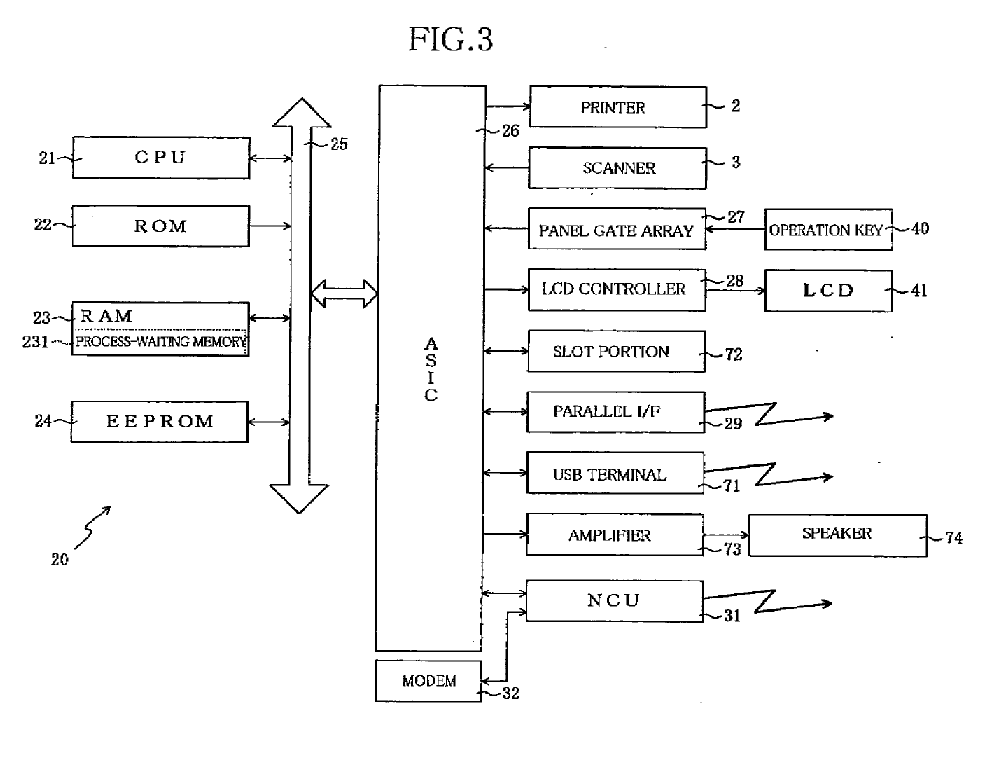

The operation panel 4 is provided on the front side of the MFD 1. As shown in FIGS. 1 and 2, the operation panel 4 has an oblongly rectangular shape so as to fit in a space located over the projecting portion 16. In other words, the operation panel 4 has a depth dimension that corresponds to a difference between a depth dimension of the printer 2 and a depth dimension of the scanner 3. The operation panel 4 is for operating the printer 2 and the scanner 3 and includes various operation keys 40 and a Liquid Crystal Display 41 (LCD) as a display device operable to display information about the MFD 1. A user can input desired commands using the operation panel 4. When predetermined commands are inputted to the MFD 1, operations of the MFD 1 are controlled by the control section 20 (shown in FIG. 3) based on information about the inputted commands.

In particular, the MFD 1 as the present embodiment is provided with various mode keys such as a copy-mode key and a FAX-mode key, each as one of the operation keys 40. A user selects one of modes of the MFD 1 through these mode keys. Where a copy mode is selected, image data read by the scanner 3 is recorded by the printer 2. Where a FAX mode is selected, image data read by the scanner 3 is sent to another facsimile device via a communication line.

The MED 1 is configured to operate based on commands transmitted, via a printer driver, a scanner driver or the like, from a computer (e.g., a PC) connected to the MFD 1, as well as commands inputted through the operation panel 4.

As shown in FIGS. 1 and 2, the LCD 41 is upsized to have a depth dimension as large as possible. On the other hand, a widthwise dimension of the LCD 41 is more than four-thirds of its depth dimension. In other words, a ratio of the widthwise dimension of the LCD 41 to its depth dimension is more than four-thirds. More specifically, in this MFD 1, the ratio of the widthwise dimension of the LCD 41 to its depth dimension is eight-thirds.

There will be explained, with reference to FIG. 3, a schematic construction of the control section 20 which controls the operations of the MFD 1. FIG. 3 is a block diagram showing the schematic construction of the control section 20 of the MFD 1. The control section 20 controls the operations of the MFD 1 including the printer 2, the scanner 3, and the operation panel 4. As shown in FIG. 3, the control section 20 is provided by a microcomputer that mainly includes a Central Processing Unit (CPU) 21, a Read Only Memory (ROM) 22, a Random Access Memory (RAM) 23, and an Electrically Erasable and Programmable ROM (EEPROM) 24. The control section 20 is connected to an Application Specific Integrated Circuit (ASIC) 26 vi a bus 25.

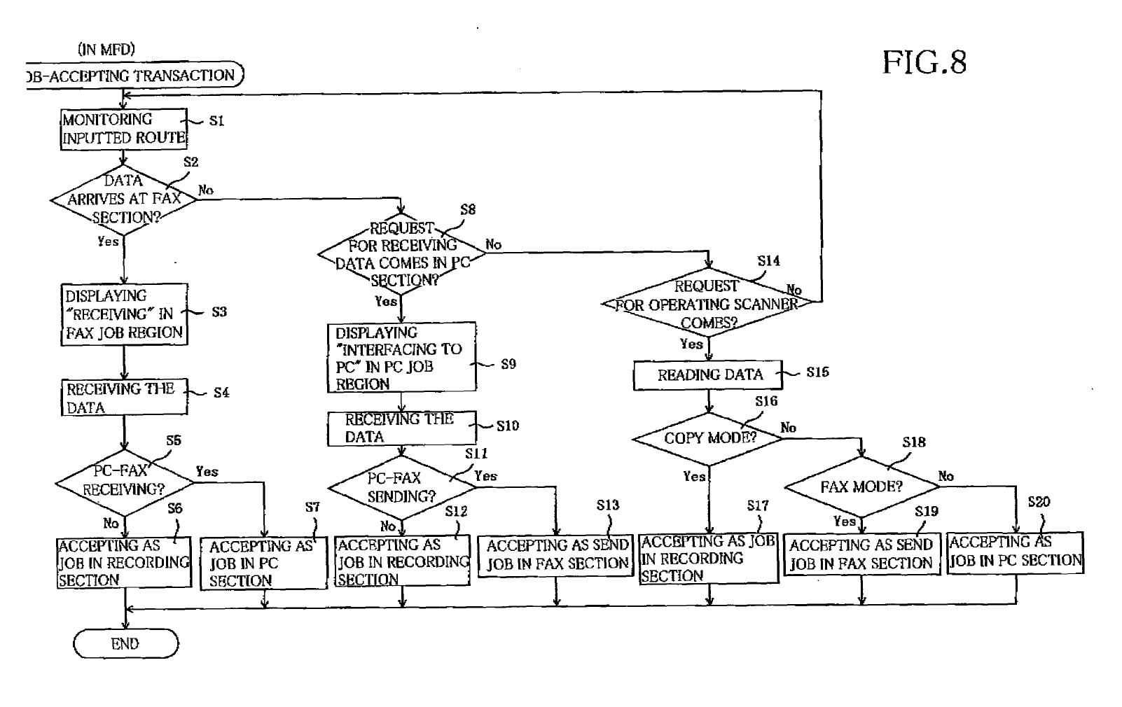

The CPU 21 functions as a processor that controls the MFD 1 as a whole. More specifically, the CPU 21 executes various programs such as programs for performing processings indicated by flow charts shown in FIGS. 8, 9, and 10. In the ROM 22, programs and the like for controlling various operations of the MFD 1 are stored.

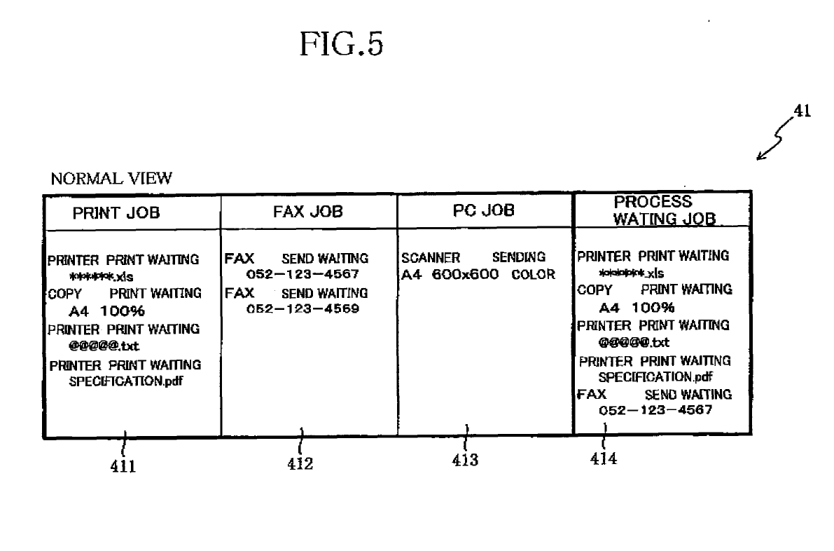

The RAM 23 functions as a working area or a storage area which temporarily records various data used when the CPU 21 executes the programs and includes a process-waiting memory 231. The process-waiting memory 231 will be described below with reference to FIG. 5.

The ASIC 26 controls operations of the printer 2, the scanner 3, the operation panel 4, and the slot section 72 in accordance with commands transmitted from the CPU 21. Configurations of the printer 2, the scanner 3, and the slot portion 72 are well known, and detailed explanations thereof are dispensed with.

To the ASIC 26, a panel gate array 27 for controlling the operation keys 40 through which desired commands are inputted to the MFD 1 is connected. The panel gate array 27 is configured to detect pressing (i.e., inputting) of any of the operation keys 40 and to output a predetermined key code signal based on a result of the detection. Each key code signal is assigned to a corresponding one of the operation keys 40. When the CPU 21 receives the key code signal from the panel gate array 27, the CPU 21 performs a suitable control processing according to a prescribed key-code processing table which is a table representative of a relationship between the key code and the control processing. The key-code processing table is stored in the ROM 22, for instance.

To the ASIC 26, a LCD controller 28 for controlling a view (i.e., a display image) displaying on the LCD 41 is further connected. The LCD controller 28 controls, based on commands of the CPU 21, the LCD 41 to display information about the operation of the printer 2 or the scanner 3. Further, the LCD controller 28 controls the LCD 41 to display the image based on the data read by the scanner 3, or the image based on the data received from the external device connected to the MFD 1 or the memory card mounted into the slot portion 72. It is noted that the control section 20 can be considered to include a job-displaying section which mainly controls views and images on the LCD 41.

To the ASIC 26, there are further connected a parallel interface 29 and the USB terminal 71 for sending/receiving data to/from the computer via a parallel cable and the USB cable, respectively. In addition, the external devices such as a digital camera and a personal computer can be connected to the USB terminal 71 via the USB cable. To the ASIC 26, there are further connected a Network Control Unit (NCU) 31 and a modem 32 for realizing the facsimile function including a FAX sending function and a FAX receiving function. The ASIC 26 may include a network interface (not shown) for sending/receiving data to/from a computer located on a network.

An amplifier 73 is further connected to the ASIC 26. The amplifier 73 causes a speaker 74, which is connected to the amplifier 73, to make a sound to output a ringing tone, a rejecting sound, a message, and the like.

There will be explained, with reference to FIG. 4, functions realized by the MFD 1 constructed as described above. FIG. 4 is a block diagram schematically showing a relationship between main sections and functions of the MFD 1. As shown in FIG. 4, the MFD 1 includes a reading section 75, a recording section 76, a FAX section 77, and a PC section 78. The reading section 75 reads a document using the scanner 3 to output its image data in a job. The recording section 76 provides recorded output in the job by recording an image on a recording sheet (i.e., a recording medium) using the printer 2. The FAX section 77 sends and receives image data and the like using the NCU 31 and the modem 32. The PC section 78 communicates with the external computer. The MFD 1 realizes various functions by causing two of these sections to cooperate with each other in suitable combination.

For example, the copying function is, as indicated by arrow (1), realized by the recording section 76 that records an image based on image data read by the reading section 75. As indicated by arrow (2), the facsimile sending function is realized by the FAX section 77 that sends image data read by the reading section 75 to another facsimile device. As indicated by arrow (3), the facsimile receiving function is realized by the recording section 76 that records an image based on input data received by the FAX section 77.

As indicated by arrow (4), the printing function is realized by the recording section 76 that records an image based on data inputted by the external computer via the PC section 78 provided by the parallel interface 29 or the USB terminal 71. As indicated by arrow (5), the scanning function is realized by the PC section 78 that outputs input data read by the reading section 75 to the external computer. As indicated by arrow (6), a PC-FAX receiving function is realized by the PC section 78 that outputs input data received by the FAX section 77 to the external computer. As indicated by arrow (7), a PC-FAX sending function is realized by the FAX section 77 that sends input data inputted from PC section 78 to another facsimile device in a facsimile communication.

The reading section 75, the recording section 76, the FAX section 77, and the PC section 78 respectively correspond to examples of processing and outputting sections which have respective functions and each of which sequentially conducts a plurality of jobs in each of which a processing related to image data provides an output, according to a corresponding one of the functions. That is, each of these sections 75-78 performs output processings, in each of which the processing related to image data is performed to provide its output, independently of each other. For example, while the recording section 76 provides the recorded output, the FAX section 77 can perform the sending or receiving processing, and the PC section 78 can perform the communicating processing with the external computers. It is noted that the recording section 76, the FAX section 77, and the PC section 78 respectively correspond to examples of specific processing and outputting sections which are specifically treated in a control of the MFD 1.

It is noted that the reading section 75, the recording section 76, the FAX section 77, and the PC section 78 conduct each job, as a unit of output processing, in which a processing related to image data provides an output. That is, each of the sections 75-78 conducts the jobs one by one. Where a new job to be subsequently conducted is accepted while each of the recording section 76, the FAX section 77, and the PC section 78 (other than the reading section 75) conducts one of the jobs, the new job is to be stored or stacked in the process-waiting memory 231 (as shown in FIG. 3). When the preceding job has been conducted, jobs stored in the process-waiting memory 231 are sequentially read out therefrom and conducted by one of the sections 76-78.

On the other hand, in the reading section 75, a document is set on the document-supply tray 9 (as shown in FIG. 1) of the ADF 7 or on the platen glass 12 (as shown in FIG. 2) during conducting, by the reading section 75, one of the jobs relating to the document, so that another document to be subsequently read cannot be set. That is, since a subsequent job cannot be accepted, a new job is not stored in the process-waiting memory 231.

There will be explained, with reference to FIG. 5, a view which indicates processing orders of the jobs and which is displayed on the LCD 41. FIG. 5 is an illustration showing an example of a normal view which represents the processing orders of the jobs. This embodiment is explained on the assumption that the normal view is displayed on the LCD 41 unless a user performs a special operation. As shown in FIG. 5, a screen of the LCD 41 is divided, in a longitudinal direction thereof, into a plurality of regions. FIG. 5 shows an example in which the screen is divided into four regions, namely, a print job region 411, a FAX job region 412, a PC job region 413, and a process-waiting job region 414. The process-waiting job region 414 is a region in which process-waiting jobs each of which is waiting for being conducted by any of the specific processing and outputting sections are displayed. The process-waiting jobs can be referred to as to-be-conducted jobs because the process-waiting jobs are identical to the to-be-conducted jobs each of which is planned to be conducted by any of the specific processing and outputting sections.

The process-waiting job region 414 is a region in which the processing order of the jobs waiting for being conducted is displayed in list form. As shown in FIG. 5, on the LCD 41, there is displayed information about each job such as a type of the function, a state of the job waiting for being conducted, a document name, a sheet size, and a ratio, for identifying each job, so that a user can recognize a content of each job and a position of each job in the processing order. For example, a view “PRINTER, PRINT WAITING, ******.xls” displayed on a top in the process-waiting job region 414 permits a user to recognize that a data “******.xls” is commanded for recording from the external computer and that the data is not processed and waits for a printing processing.

In the process-waiting job region 414, the jobs waiting for being conducted by the recording section 76, FAX section 77, and the PC section 78 are displayed in a mixed manner. However, since the recording section 76, the FAX section 77, and the PC section 78 perform the respective output processings independently of each other, the processing order displayed on the process-waiting job region 414 may differ from an order in which the output processing is to be actually completed.

For example, although a job displayed on a bottom in the process-waiting job region 414 is located at a fifth position in an entire processing order of process-waiting jobs, the job is located at a first position in a processing order of process-waiting jobs to be conducted by the FAX section 77. Consequently, the output processing of the job is actually to be speedily completed. Thus, it is difficult to recognize an actual timing of conducting each job only on the basis of a view in the process-waiting job region 414. Accordingly, in the present embodiment, there are displayed, on the LCD 41, respective processing orders of the process-waiting jobs which belongs to each of groups and is to be conducted by a corresponding one of the recording section 76, the FAX section 77, and the PC section 78. Hereinafter, the respective processing orders of the groups respectively corresponding to sections 76-78 may be referred to as “job-group processing orders”.

The print job region 411 is assigned to the recording section 76 (as shown in FIG. 4). In the print job region 411, the jobs stored in the process-waiting memory 231 and waiting for being conducted by the recording section 76 are displayed in a row. As a result, the job-group processing order of the jobs to be conducted by the recording section 76 are displayed in the print job region 411.

The FAX job region 412 is assigned to the FAX section 77 (as shown in FIG. 4). In the FAX job region 412, the jobs stored in the process-waiting memory 231 and waiting for being conducted by the FAX section 77 are displayed in a row. As a result, the job-group processing order of the jobs to be conducted by the FAX section 77 are displayed in the FAX job region 412.

The PC job region 413 is assigned to the PC section 78 (as shown in FIG. 4). In the PC job region 413, the jobs stored in the process-waiting memory 231 and waiting for being conducted by the PC section 78 are displayed in a row. As a result, the job-group processing order of the jobs to be conducted by the PC section 78 are displayed in the PC job region 413.

As described above, there are displayed, on the LCD 41, respective processing orders of the groups into which the process-waiting jobs are separated and which respectively correspond to the recording section 76, the FAX section 77, and the PC section 78. Thus, a user can easily and intuitively recognize the actual timing of conducting each job. For example, the user can recognize, in one glance, that the job displayed on the bottom in the process-waiting job region 414 is located at the first position in the job-group processing order of the process-waiting jobs to be conducted by the FAX section 77, although the job is the fifth job located at the fifth position in the entire processing order of the process-waiting jobs. Consequently, the user can recognize that the processing of the job is actually to be speedily completed. Thus, the user can accurately and intuitively recognize the actual timing of conducting each job. In addition, the respective job-group processing orders in the recording section 76, the FAX section 77, and the PC section 78 are displayed on one screen, so that the user can see the job-group processing orders in respective sections 76-78 at sight and easily recognize the actual timing of conducting each job. It is noted that, as described above, there is not provided a displaying region of the reading section 75 whose jobs waiting for being conducted are not stored in the process-waiting memory 231. Thus, a screen can be effectively utilized.

Further, as shown in FIG. 5, information about jobs being conducted may be displayed, as well as the jobs not being conducted, in the print job region 411, the FAX job region 412, and the PC job region 413. This permits a user to know a progress of processing of the jobs, thereby improving a convenience for the user.

Since the actual timing of conducting each job can be thus accurately recognized, a user may require to change the job-group processing orders by changing the processing and outputting sections. For example, a user may require to add an additional processing, utilizing a time for waiting for a processing of a job. The additional processing includes a recording processing with respect to a job waiting for a send processing in the facsimile communication to confirm a content of the job before sending. The additional processing further includes a transmission, to the external computer, with respect to a job waiting for a recording processing in the copying function, in order to save the job to the external computer. Thus, as explained below, the MFD 1 as the present embodiment can change the job-group processing orders of the jobs displayed on the LCD 41 according to prompts on the LCD 41 such that one of the process-waiting jobs, that has been planned to be conducted by one (may be referred to as a planned processing and outputting section) of the specific processing and outputting sections is conducted by another (may be referred to as a different processing and outputting section) of the specific processing and outputting sections.

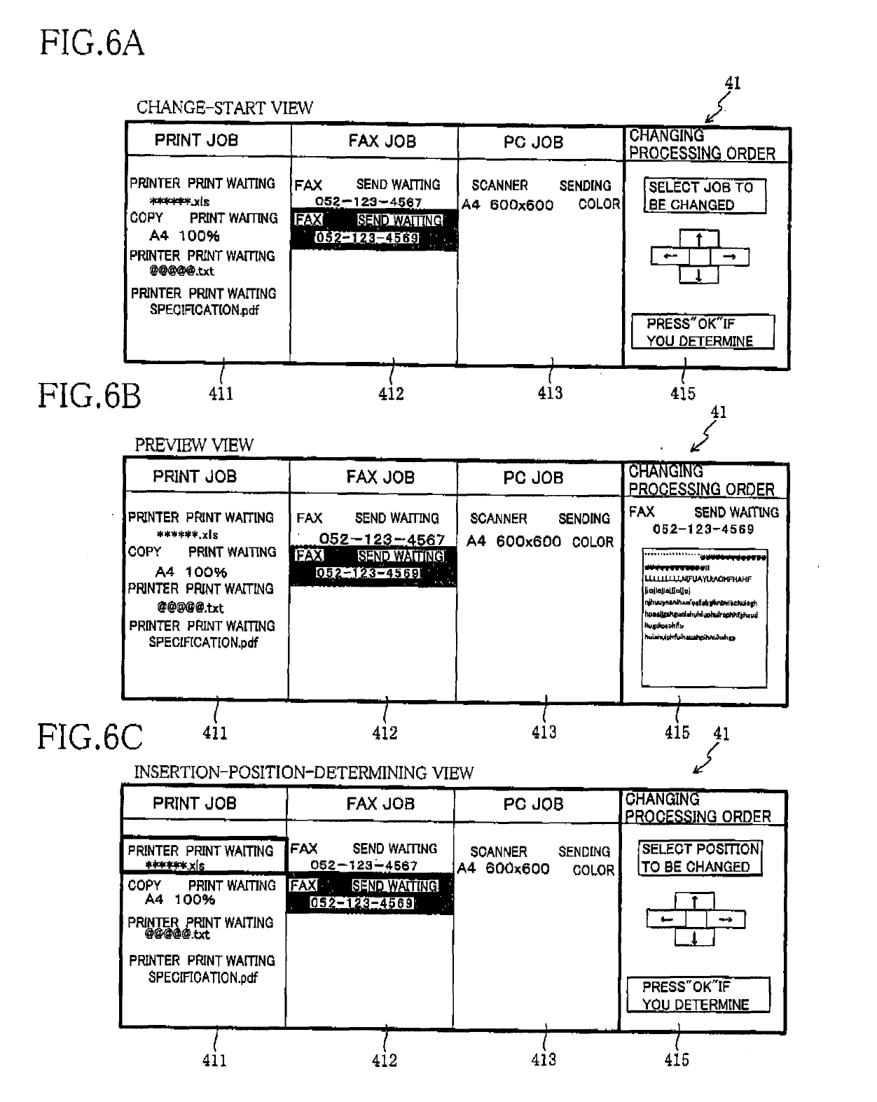

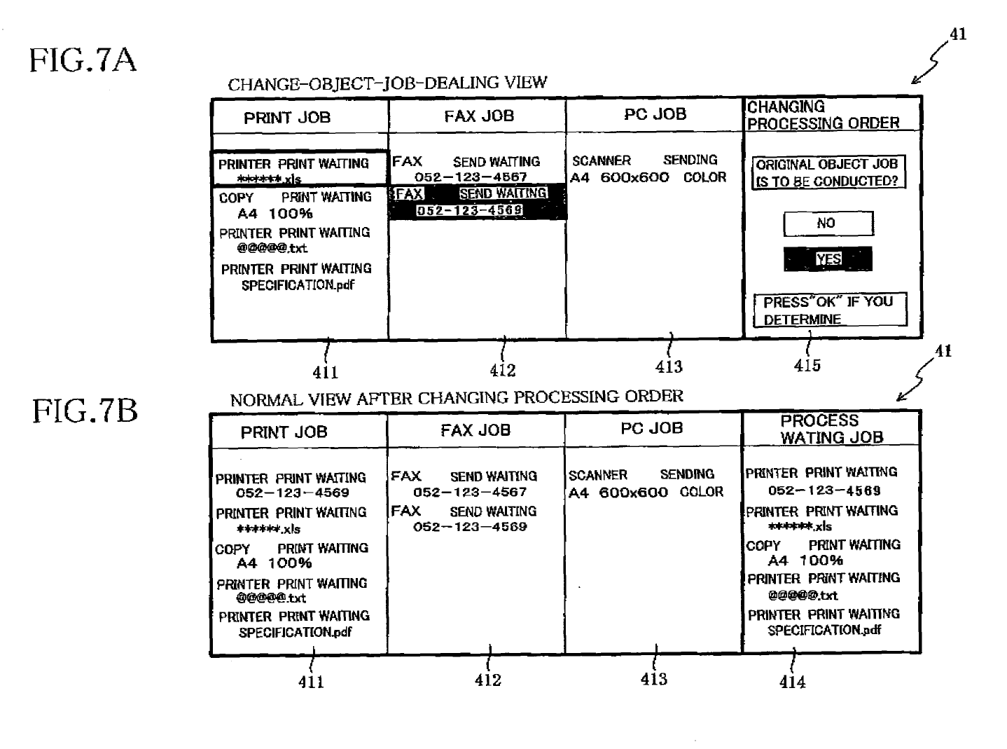

There will be explained, with reference to FIGS. 6A, 6B, 6C, 7A, and 7B, a changing operation of a user in which the job-group processing orders of the jobs is changed. FIGS. 6A, 6B, 6C, 7A, and 7B are illustrations showing a transition of views in the changing operation of the job-group processing orders of the jobs. FIG. 6A is an illustration showing an example of a change-start view which is displayed on the LCD 41 in a case where a user commands for changing the job-group processing orders of the jobs. As shown in FIG. 6A, the change-start view is a view in which one screen is divided into four regions, namely, the print job region 411, the FAX job region 412, the PC job region 413, and a changing-operation displaying region 415. As shown in FIG. 6A, the changing-operation displaying region 415 is a region which is provided in place of the process-waiting job region 414 in the normal view explained with reference to FIG. 5 and in which a prompt for operating or a preview image that will be explained below is displayed. Thus, the job-group processing orders and the prompt for changing operation are displayed simultaneously, so that a user can perform various operations while visually recognizing the job-group processing orders and the prompt simultaneously, thereby improving an usability of the MFD 1.

In this change-start view, one of the jobs displayed in the print job region 411, the FAX job region 412, and the PC job region 413 is displayed in an inverted manner as a job being selected (i.e., a selected job), such that the user can identify the selected job from the process-waiting jobs other than the selected job. In FIG. 6A, an inverted area is shown in grey. A user can change a position of the inverted area on this view, for example, by inputting rightward, leftward, upward, or downward direction through the operation keys 40. A user presses down a determination key (i.e., an OK key, not shown) of the operation keys 40 after a job to be selected is displayed in the inverted manner by the selecting operation of the user with the operation keys 40. Thus, the job in the inverted area is selected or determined as an object job to be changed (hereinafter, may be referred to as a change-object job), and then the preview view is displayed as shown in FIG. 6B.

FIG. 6B is an illustration showing an example of the preview view. As shown in FIG. 6B, in the preview view, the preview image showing a content of the determined change-object job is displayed in the changing-operation displaying region 415. That is, an image based on image data processed in a selected one of the process-waiting jobs which is selected by a selecting operation of a user is displayed in the changing-operation displaying region 415. A user can grasp a more detailed content of the determined change-object job with this preview image. In this preview view, one of the jobs displayed in the print job region 411, the FAX job region 412, and the PC job region 413, which one is determined by an operation of a user is displayed in the inverted manner. The user selects a confirmation or a cancellation of conducting the determined job, while the preview view is displayed. Where the user selects the confirmation, the job displayed in the inverted manner is confirmed as the change-object job. Then, an insertion-position-determining-view is displayed as shown in FIG. 6C.

FIG. 6C is an illustration showing an example of the insertion-position-determining view. As shown in FIG. 6C, in the insertion-position-determining view, one of the jobs displayed in the print job region 411, the FAX job region 412, and the PC job region 413 is displayed as a job being selected, with the job enclosed in a rectangular box. That is, the job is displayed in an area designated by a designating operation of a user within a view of the process-waiting jobs. A user can designate or select a position of the displayed rectangular box, for example, by inputting rightward, leftward, upward, or downward direction through the operation keys 40. A user designates one of the jobs and presses down the determination key (i.e., the OK key, not shown) of the operation keys 40. As a result, a position of the job enclosed in the rectangular box in one of the job-group processing orders is determined as a position, in the job-group processing orders, into which the change-object job is to be inserted. That is, the position of the change-object job enclosed in the rectangular box in one of the job-group processing orders is determined in a relationship between the change-object job and at least one of the process-waiting jobs which has been planned to be conducted in one of the specific processing and outputting section by which the change-object job is to be conducted. Then, a change-object-job-dealing view is displayed as shown in FIG. 7A.

FIG. 7A is an illustration showing an example of the change-object-job-dealing view. As shown in FIG. 7A, the change-object-job-dealing view shows an inquiry of a user. This change-object-job-dealing view inquires of the user whether an original object job, as a change-object job having been planned to be conducted by one of the specific processing and outputting sections, is to be conducted or not. In other words, the change-object-job-dealing view inquires whether a planning of the conduction of the change-object job is maintained or canceled. The user selects whether the original object job is to be conducted or not by inputting upward, or downward direction with the operation keys 40. Then, the user presses down the determination key (i.e., the OK key, not shown) of the operation keys 40. As a result, whether the original object job is to be conducted or not by the one of the specific processing and outputting sections that has been planned to conduct the original object job is determined. Then, a normal view is displayed as shown in FIG. 7B. It is noted that, in the changing operation, the change-object job can be considered to be conducted, as the original object job, by the planned specific processing and outputting section that has been planned to conduct the original object job and to be conducted, as a new object job, by the different specific processing and outputting section. On the other hand, it can be considered that a new change-object job is produced when the change-object job is conducted by the different specific processing and outputting section. In the present embodiment, it will be mainly described that the change-object job is considered to be conducted as the original object job and the new object job.

FIG. 7B is an illustration showing the normal view after changing of the job-group processing orders of the jobs. As shown in FIG. 7B, the process-waiting job region 414 is displayed in the normal view in place of the changing-operation displaying region 415. Since the job waiting for a send processing in the facsimile communication is inserted into a first position in the job-group processing order of the jobs waiting for a recording processing, and the original object job, namely, the job waiting for the send processing in the facsimile communication is selected to be conducted also by one of the specific processing and outputting sections that has been planned to conduct the original object job, the normal view shows, as shown in FIG. 7B, changed job-group processing orders of the jobs in which the original object job still exists and a new object job is added into a position into which the job is determined to be inserted. This change permits the recording section 76 to record the job waiting for the send processing in the facsimile communication, and permits a user to confirm a content of the job in advance while the user waits for the send processing in the facsimile communication. The change-object job originally waiting for the send processing in the facsimile communication is conducted such that the send processing is performed in an original order.

In the MFD 1, a user can accurately and intuitively recognize an actual timing of conducting each job, and change the job-group processing orders of the jobs on the basis of the accurate recognition. Thus, the user can change the job-group processing orders of the jobs to suitable ones for the user and effectively use a waiting time.

There will be next explained transactions performed by the MFD 1 constructed as described above, with reference to flow charts indicated in FIGS. 8, 9, and 10.

FIG. 8 is a flow chart indicating a flow of a transaction for accepting the jobs (which may be referred to as a “job-accepting transaction”). The job-accepting transaction shown in FIG. 8 is performed periodically at predetermined time intervals after a power of the MFD 1 is turned on. It is noted that the following explanation is described on the assumption that the normal view explained with reference to FIG. 5 is displayed on the LCD 41, while the job-accepting transaction is performed.

Initially, an inputted route of the MFD 1 is monitored (S1). Then, whether data arrives at the FAX section 77 or not is judged (S2). Where the data arrives at the FAX section 77 (S2: Yes), the term “RECEIVING” is displayed in the FAX job region 412 (shown in FIG. 5) of the normal view (S3). Then, the data is received (S4). It is noted that the term “RECEIVING” displayed on the FAX job region 412 is turned off, upon completing the reception of the data. Subsequently, whether the received data is to be received using the PC-FAX receiving function or not is judged (S5). It is noted that a user has set in advance that the received data is to be received using a normal facsimile receiving function in which the recording section 76 records an image on the basis of the received data, or using the PC-FAX receiving function in which the received data is stored in the external computer. S5 follows this setting of the user.

As a result of the judgment, where the received data is to be received not using the PC-FAX receiving function (S5: No), that is, where the received data is to be received using the normal facsimile receiving function, an output processing relating to the inputted data (i.e., the received data) is accepted as the job to be conducted by the recording section 76 (S6), and the transaction is completed. On the other hand, where the received data is to be received using the PC-FAX receiving function (S5: Yes), the output processing relating to the inputted data is accepted as the job to be conducted by the PC section 78 (S7), and the transaction is completed.

On the other hand, where no data arrives at the FAX section 77 (S2: No) and where a request for receiving data comes in the PC section 78 from the external computer (S8: Yes), the term “INTERFACING TO PC” is displayed on the PC job region 413 (shown in FIG. 5) of the normal view (S9). Then, the data is received (S10). It is noted that the term “INTERFACING TO PC” displayed on the PC job region 413 is turned off, upon completing the reception of the data. Subsequently, whether the received data is for a PC-FAX sending or not is judged (S11).

As a result of the judgment, where the received data is not for the PC-FAX sending (S11: No), that is, where the data received from the external computer is for the printing function in which the recording section 76 records an image on the basis of various kinds of data, the output processing relating to the inputted data (i.e., the received data) is accepted as the job to be conducted by the recording section 76 (S12), and the transaction is completed.

On the other hand, where the received data is for the PC-FAX sending (S11: Yes), that is, where the data received from the external computer is for the PC-FAX sending function in which the data is sent in the facsimile communication via the MFD 1, the output processing relating to the inputted data is accepted as a job to be conducted by the FAX section 77 (S13), and the transaction is completed.

Where no data arrives at the FAX section 77 (S2 No), where no request for receiving data comes in the PC section 78 from the external computer (S8: No), and where a request for operating the scanner comes (S14: Yes), the reading section 75 is processed to read a document and to obtain its image data (S15). It is noted that the request for operating the scanner is produced by a user pressing down a start key (not shown) provided in the operation panel 4 of the MFD 1.

Next, whether a mode being selected by a user is the copy mode or not is judged (S86). Where the copy mode is being selected (S16: Yes), an output processing relating to the data inputted from the reading section 75 is accepted as the job to be conducted by the recording section 76 (S17), and the transaction is completed.

Next, where the mode being selected is not the copy mode (S16: No) but the FAX mode (S18: Yes), the output processing relating to the data inputted from the reading section 75 is accepted as the job to be conducted by the FAX section 77 (S19), and the transaction is completed.

Next, where the mode being selected is not the copy mode (S16: No) or the FAX mode (S18: No), the output processing relating to the data inputted from the reading section 75 is accepted as the job to be conducted by the PC section 78 (S20), and the transaction is completed.

In the job-accepting transaction, the inputted data is accepted as a job to be conducted by any of the recording section 76, the FAX section 77, and the PC section 78.

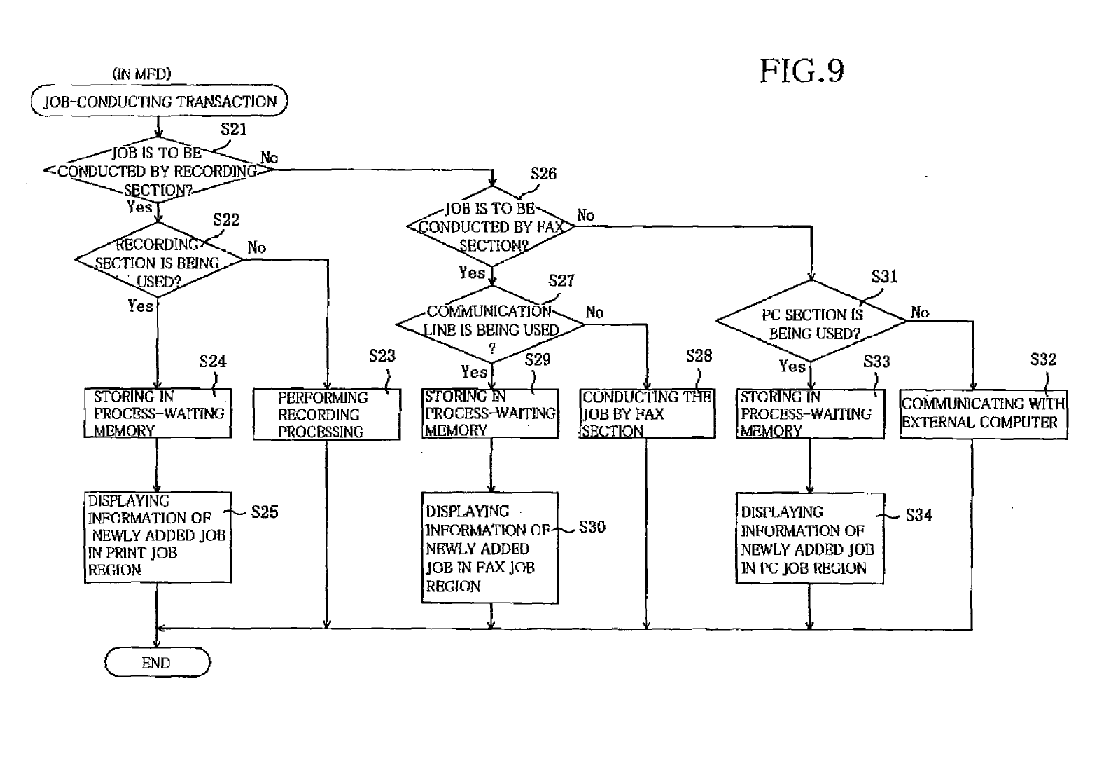

There will be next explained a transaction of conducting the jobs (hereinafter, may be referred to as a “job-conducting transaction”) with reference to the flow chart indicated in FIG. 9. FIG. 9 is the flow chart indicating the flow of the job-conducting transaction. This job-conducting transaction starts when the job is accepted in the job-accepting transaction (shown in FIG. 8). It is noted that the following explanation is described on the assumption that the normal view explained with reference to FIG. 5 is displayed on the LCD 41, while the job-conducting transaction is performed.

Initially, whether the accepted job is to be conducted by the recording section 76 (shown in FIG. 4) or not is judged (S21). Where the accepted job is to be conducted by the recording section 76 (S21: Yes), whether the recording section 76 is being used or not (that is, whether the recording section 76 is conducting another job which precedes the accepted job or not) is judged (S22). Where the recording section 76 is not being used (S22: No), the recording section 76 performs a recording processing (S23), and the transaction is completed.

On the other hand, the recording section 76 is being used (S22: Yes), the accepted job is stored in the process-waiting memory 231 (shown in FIG. 1) (S24). Then, information about a newly added job is shown on the bottom in the print job region 411 (shown in FIG. 5) of the normal view displayed on the LCD 41 (S25), and the transaction is completed.

On the other hand, where the accepted job is not to be conducted by the recording section 76 (shown in FIG. 4) (S21: No), whether the accepted job is to be conducted by the FAX section 77 (shown in FIG. 4) or not is judged (S26). Where the accepted job is to be conducted by the FAX section 77 (S26: Yes), whether a communication line for sending and receiving in the facsimile communication is being used or not (that is, the FAX section 77 is being used or not) is judged (S27). Where the communication line is not used (S27: No), the job is conducted by FAX section 77 (S28), and the transaction is completed.

On the other hand, where the FAX section 77 is being used (S27: Yes), the accepted job is stored in the process-waiting memory 231 (shown in FIG. 1) (S29). Then, information about a newly added job is shown on the bottom in the FAX job region 412 (shown in FIG. 5) of the normal view displayed on the LCD 41 (S30), and the transaction is completed.

On the other hand, where the accepted job is not to be conducted by the recording section 76 (S21: No) or the FAX section 77 (S26: No), the accepted job is not to be conducted by the PC section 78 (shown in FIG. 4), and thus whether the PC section 78 is communicating with the external computer or not (that is, the PC section 78 is being used or not) is judged (S31). Where the PC section 78 is not being used (S31: No), the PC section 78 is communicated with the external computer (S32), and the transaction is completed.

On the other hand, the PC section 78 is being used (S31: Yes), the accepted job is stored in the process-waiting memory 231 (shown in FIG. 1) (S33). Then, information about a newly added job is shown on the bottom in the PC job region 413 (shown in FIG. 5) of the normal view displayed on the LCD 41 (S34), and the transaction is completed.

It is noted that the jobs stored in the process-waiting memory 231 are conducted in a multitasking manner by the recording section 76, the FAX section 77, and the PC section 78. In other words, the jobs are concurrently conducted by the recording section 76, the FAX section 77, and the PC section 78. Thus, the jobs stored in the process-waiting memory 231 are concurrently and sequentially conducted while the job-accepting transaction shown in FIG. 8 and the job-conducting transaction shown in FIG. 9 are performed. However, the multitasking manner is well known, and a detailed explanation thereof is dispensed with.

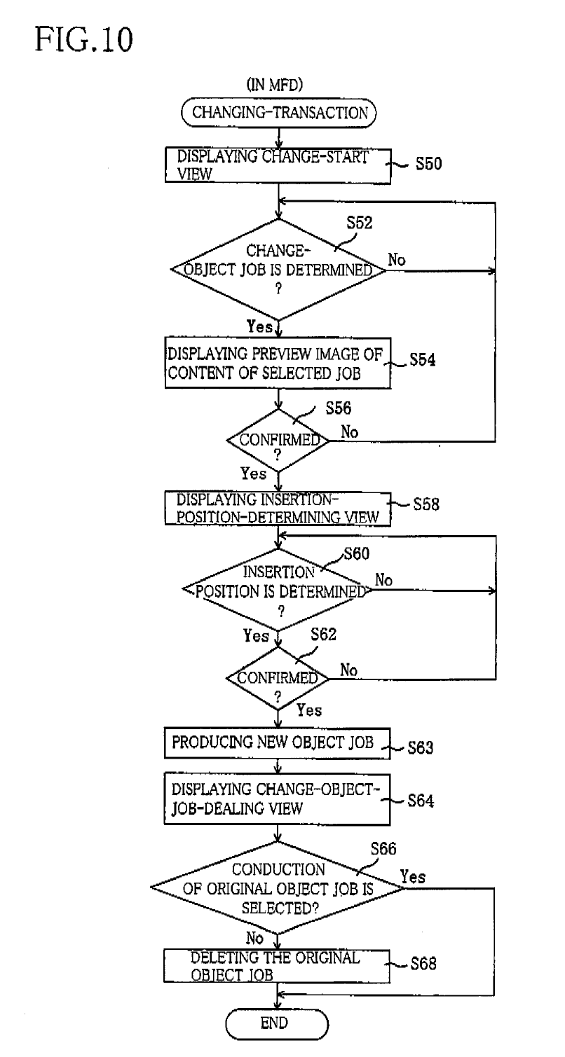

FIG. 10 is a flow chart indicating a flow of a changing transaction performed in the MFD 1. The changing transaction is for conducting the change-object job, which has been planned to be conducted by one of the specific processing and outputting sections, by another of the specific processing and outputting sections. The changing transaction starts when a command of changing the job-group processing orders of the jobs is given. It is noted that the changing command of the job-group processing orders is inputted by a user operating the operation keys 40 in a predetermined manner.

Initially, the change-start view (shown in FIG. 6A) is displayed on the LCD 41 (S50). Then, whether the change-object job is determined or not is judged (S52). Until the change-object job is determined (S52: No), the MFD 1 stands by. On the other hand, as explained with reference to FIG. GA, one of the jobs displayed on the change-start view, which one is selected by a user is displayed in the inverted manner. When the user presses down the determination key (i.e., the OK key, not shown) of the operation keys 40, the change-object job is determined (S52: Yes). Subsequently, the preview view (shown in FIG. 5B) is displayed, and then the preview image of the determined job is displayed (S54). This permits the user to understand a detailed content of the change-object job.

It is noted that, in view of the above, the control section 20 can be considered to include a job-image-displaying section which is configured to display an image based on image data processed in a selected one of to-be-conducted jobs which is selected by a selecting operation of a user, and which performs tasks of S54.

Next, whether the determined job is confirmed or not by the user pressing down the determination key (not shown) of the operation keys 40 is judged (S56). For example, where the determined job is not confirmed by the user pressing down the cancel key (S56: No), this transaction goes back to S52, and tasks of S52, S54, 856 is repeatedly performed until the change-object job is confirmed. As thus described, the preview image is displayed before the change-object job is confirmed. Consequently, the user can confirm whether the change-object job is to be confirmed as the original object job or not after the user visually recognizes a detailed content of the job, thereby improving an usability of the MFD 1.

It is noted that, in view of the above, the control section 20 can be considered to include a object-job-determining section which is configured to determine the object job on the basis of a determining operation of a user, and which performs the tasks of S52, S54, and S56.

Where the change-object job is confirmed (S56: Yes) while the tasks of S52, S54, S56 is repeatedly performed as thus described, the insertion-position-determining view (shown in FIG. 6C) is displayed (S58). Then, in the insertion-position-determining view, whether a position (hereinafter, may be referred to as an “insertion position”) into which the change-object job is to be inserted is determined or not is judged (S60). That is, whether one of the specific processing and outputting sections by which a new object job is to be conducted, and a position of the new object job in a job-group processing order in the one of the specific processing and outputting section are determined or not is judged. Until the insertion position is determined (S60: No), the MFD 1 stands by. As explained with reference to FIG. 6C, one of the jobs displayed in the insertion-position-determining view, which one is selected by a user is displayed, with the job enclosed in the rectangular box. When the user presses down the determination key (i.e., the OK key, not shown) of the operation keys 40, it is determined that the job is to be conducted by one of the specific processing and outputting sections corresponding to a region in which the rectangular box is located, and the insertion position is located at a position immediately preceding the job enclosed in the rectangular box, in a relationship between the job and at least one of process-waiting jobs in the one of the specific processing and outputting section.

Where the insertion position is determined as described (S60: Yes), whether the determined insertion position is confirmed or not is judged by a user pressing down the determination key (not shown) of the operation keys 40 (S62). For example, where the insertion position is not confirmed by the user pressing down the cancel key (S62: No), this transaction goes back to S60, and tasks of the S60 and S62 are repeatedly performed until the insertion position is confirmed.

It is noted that, in view of the above, the control section 20 can be considered to include a different-processing-and-outputting-section-determining section which is configured to determine, on the basis of a determining operation of a user, the different processing and outputting section and a position of the change-object job in one of the job-group processing orders in the different processing and outputting section in a relationship between the change-object job and at least one of the process-waiting jobs which has been planned to be conducted in the different processing and outputting section, and which performs the tasks of S60 and S62.

Where the insertion position is confirmed (S62: Yes), a new object job corresponding to the determined insertion position is produced on the basis of the original object job (S63). This new, object job is stored in the process-waiting memory 231 (shown in FIG. 3), and to be conducted by a confirmed one of the specific processing and outputting sections and according to a position in a confirmed one of the job-group processing orders. Subsequently, the change-object-job-dealing view (shown in FIG. 7A) is displayed (S64). As explained with reference to FIG. 7A, this change-object-job-dealing view inquires of the user whether the original object job is to be conducted or not.

It is noted that, in view of the above, the control section 20 can be considered to include an assistant-view-displaying section which is configured to display an assistant view for assisting the changing operation of the user, and which performs tasks of S50, S54, S58, and S64.

Where the user selects the conduction of the original object job (S66: Yes), S68 is skipped, and the transaction is completed. In this case, the original object job remains intact. Thus, the original object job is conducted by the planned specific processing and outputting section and according to a position in one of the job-group processing orders which has been planned. That is, the output processing is performed by both of the planned specific processing and outputting section and the different specific processing and outputting section, whereby the usability of the MFD 1 is improved. On the other hand, where the user does not select the conduction of the original object job (S66: No), the original object job is deleted (S68), and the transaction is completed. That is, the original object job is selectively maintained and canceled in S66. In this case, the original object job is not conducted, whereby a time required for conducting and consumables for the processes can be saved.

It is noted that, in view of the above, the control section 20 can be considered to include a job-canceling section which is configured to cancel a planning of the conduction of the change-object job by the planned processing and outputting section on the basis of a determination of the different processing and outputting section by the different-processing-and-outputting-section-determining section, and which performs a task of S66.

It is further noted that, in view of the above, the control section 20 can be considered to include a processing-and-outputting-section-changing section configured to perform the changing transaction, so that a change-object job that has been planned to be conducted by the planned processing and outputting section is conducted by the different processing and outputting section.

In the changing transaction, one of the jobs in a processing order displayed on the LCD 41 can be conducted by one of the specific processing and outputting sections other than another of the specific processing and outputting sections by which the one job has been planned to be conducted, whereby the usability of the MFD 1 is improved.

In the MFD 1, the processing orders of the jobs are displayed in each of the recording section 76, the FAX section 77, and the PC section 78. Thus, it is easy for a user to intuitively recognize an actual timing of conducting each job.

It is to be understood that the present invention is not limited to the details of the illustrated embodiment, but may be embodied with various changes and modifications, which may occur to those skilled in the art, without departing from the spirit and scope of the invention.

For example, in the above-described embodiment, the MFD 1 realizes the copying function, the FAX sending function and the FAX receiving function, the printing function, the scanning function, the PC-FAX sending function, and the PC-FAX receiving function. However, the MFD 1 may not include all of the above-described functions in applying the present invention to the MFD 1. In addition, the MFD 1 can record an image on an overhead transparency film, a cloth, or the like as well as the recording sheet. Further, the MFD 1 may realize a media function in which an image is recorded on the recording sheet on the basis of data received from the external device such as a digital camera, or in which an image is recorded on the recording sheet on the basis of data or the like stored in one of various storage media such as a memory card which is mounted into the MFD 1 by a user.

Furthermore, the MFD 1 includes the reading section 75, the recording section 76, the FAX section 77, and the PC section 78, but may not include all of these sections in applying the present invention to the MFD 1. In addition, the MFD 1 may include another configuration as one of the processing and outputting sections.

What is claimed is:

1. A multi-function apparatus, comprising:
a plurality of processing and outputting sections which have respective functions and each of which sequentially conducts a plurality of jobs in each of which a processing related to image data provides an output, according to a corresponding one of the functions, wherein the plurality of processing and outputting sections comprise, as at least a portion thereof, a plurality of specific processing and outputting sections; and
a job-displaying section configured to display a plurality of to-be-conducted jobs each of which is to be conducted by any of the specific processing and outputting sections, such that the to-be-conducted jobs are separated into a plurality of groups corresponding to the specific processing and outputting sections, respectivel.

2. The multi-function apparatus according to claim 1, further comprising a display device operable to display information about the multi-function apparatus,
wherein the job-displaying section is configured to display the plurality of to-be-conducted jobs on the display device.

3. The multi-function apparatus according to claim 1,
wherein the job-displaying section is configured to display the plurality of to-be-conducted jobs such that a user can recognize a processing order of at least one of the plurality of to-be-conducted jobs which belongs to each of the plurality of groups and is to be conducted by a corresponding one of the plurality of specific processing and outputting sections.

4. The multi-function apparatus according to claim 1,
wherein the job-displaying section is configured to display at least one of the plurality of to-be-conducted jobs which belongs to each of the plurality of groups and is to be conducted by a corresponding one of the plurality of specific processing and outputting sections, in a row in a processing order of the at least one of the plurality of to-be-conducted jobs.

5. The multi-function apparatus according to claim 1,
wherein the job-displaying section is configured to display the plurality of to-be-conducted jobs in one screen.

6. The multi-function apparatus according to claim 5,
wherein a plurality of regions corresponding to the plurality of specific processing and outputting sections, respectively, are provided in the one screen, and
wherein the job-displaying section is configured to display, in each of the plurality of regions, at least one of the plurality of to-be-conducted jobs which belongs to a corresponding one of the plurality of groups and is to be conducted by a corresponding one of the plurality of specific processing and outputting sections.

7. The multi-function apparatus according to claim 1,
wherein the job-displaying section is configured to display a selected one of the plurality of to-be-conducted jobs which is selected by a selecting operation of a user, such that the user can identify the selected job from the plurality of to-be-conducted jobs other than the selected job.

8. The multi-function apparatus according to claim 1, further comprising a job-image-displaying section configured to display an image based on image data processed in a selected one of the plurality of to-be-conducted jobs which is selected by a selecting operation of a user.

9. The multi-function apparatus according to claim 1, further comprising a processing-and-outputting-section-changing section configured to perform a processing-and-outputting-section-changing transaction, so that an object job, as one of the plurality of to-be-conducted jobs, that has been planned to be conducted by a planned processing and outputting section as one of the plurality of specific processing and outputting sections is conducted by a different processing and outputting section as an other of the plurality of specific processing and outputting sections than the planned processing and outputting section.

10. The multi-function apparatus according to claim 9,
wherein the processing-and-outputting-section-changing section is configured to perform a task, as a portion of the processing-and-outputting-section-changing transaction, in which a position of the object job in a processing order in the different processing and outputting section is determined in a relationship between the object job and at least one of the plurality of to-be-conducted jobs which has been planned to be conducted in the different processing and outputting section.

11. The multi-function apparatus according to claim 9,
wherein the processing-and-outputting-section-changing section is configured to cancel the planning of the conduction of the object job by the planned processing and outputting section.

12. The multi-function apparatus according to claim 9,
wherein the processing-and-outputting-section-changing section is configured to maintain the planning of the conduction of the object job by the planned processing and outputting section.

13. The multi-function apparatus according to claim 9,
wherein the processing-and-outputting-section-changing section is configured to perform a task, as a portion of the processing-and-outputting-section-changing transaction, in which the planning of the conduction of the object job by the planned processing and outputting section is selectively canceled and maintained.

14. The multi-function apparatus according to claim 9,
wherein the processing-and-outputting-section-changing section configured to perform the processing-and-outputting-section-changing transaction on the basis of a changing operation of a user, and
wherein the multi-function apparatus further comprises an assistant-view-displaying section configured to display an assistant view for assisting the changing operation of the user.

15. The multi-function apparatus according to claim 14,
wherein the assistant-view-displaying section includes a job-image-displaying section configured to display an image, as at least a portion of the assistant view, based on image data processed in a selected one of the plurality of to-be-conducted jobs which is selected by a selecting operation of a user.

16. The multi-function apparatus according to claim 9,
wherein the processing-and-outputting-section-changing section includes an object-job-determining section configured to determine the object job on the basis of a determining operation of a user.

17. The multi-function apparatus according to claim 16, further comprising a job-image-displaying section configured to display an image based on image data processed in a selected one of the plurality of to-be-conducted jobs which is selected by a selecting operation of a user, as at least a portion of the determining operation,
wherein the object-job-determining section is configured to determine the selected job as the object job.

18. The multi-function apparatus according to claim 16,
wherein the job-displaying section is configured to display a selected one of the plurality of to-be-conducted jobs which is selected by a selecting operation of a user, as at least a portion of the determining operation, such that the user can identify the selected job from the plurality of to-be-conducted jobs other than the selected job, and
wherein the object-job-determining section is configured to determine the selected job as the object job.

19. The multi-function apparatus according to claim 9,
wherein the processing-and-outputting-section-changing section includes a different-processing-and-outputting-section-determining section configured to determine the different processing and outputting section on the basis of a determining operation of a user.

20. The multi-function apparatus according to claim 19,
wherein the different-processing-and-outputting-section-determining section is configured to further determine, on the basis of the determining operation of the user, a position of the object job in a processing order in the different processing and outputting section in a relationship between the object job and at least one of the plurality of to-be-conducted jobs which has been planned to be conducted in the different processing and outputting section.

21. The multi-function apparatus according to claim 20,
wherein the job-displaying section is configured to display at least one of the plurality of to-be-conducted jobs which belongs to each of the plurality of groups and is to be conducted by a corresponding one of the plurality of specific processing and outputting sections, in a tow in a processing order of the at least one of the plurality of to-be-conducted jobs, and is configured to display an area designated by a designating operation of the user, as at least a portion of the determining operation, within a view of the plurality of to-be-conducted jobs forming a plurality of rows corresponding to the plurality of specific processing and outputting sections, respectively, such that the user can identify the designated area within the view of the plurality of to-be-conducted jobs, and
wherein the different-processing-and-outputting-section-determining section is configured to determine, as the different processing and outputting section, one of the plurality of specific processing and outputting sections that corresponds to one of the plurality of rows of to-be-conducted jobs within the view of the plurality of to-be-conducted jobs, in which one row the designated area is located, and to determine, as the position of the object job in the processing order in the different processing and outputting section, a position in the processing order, which position corresponds to a position of the designated area in one of the plurality of rows of to-be-conducted jobs in which one row the designated area is located.

22. The multi-function apparatus according to claim 9,
wherein the processing-and-outputting-section-changing section includes;
a different-processing-and-outputting-section-determining section configured to determine the different processing and outputting section on the basis of a determining operation of a user; and
a job-canceling section configured to cancel the planning of the conduction of the object job by the planned processing and outputting section on the basis of a determination of the different processing and outputting section by the different-processing-and-outputting-section-determining section.

23. The multi-function apparatus according to claim 1, wherein the plurality of processing and outputting sections comprise (a) an image-recording section configured to provide an output in which an image is recorded on a recording medium on the basis of image data, (b) a facsimile-sending section configured to provide an output in which image data is sent in a facsimile communication, (c) a data-sending section configured to provide an output in which image data is sent to a computer connected to the multi-function apparatus, and (d) an image-reading section configured to read an image formed on a recording medium and to provide an output in which image data obtained by the reading are outputted to the plurality of processing and outputting sections other than the image-reading section.

24. The multi-function apparatus according to claim 23,
wherein the plurality of specific processing and outputting sections do not include the image-reading section.
